(19) United States
(12) Patent Application Publication
(10) Pub. No.: US 2002/0076584 A1
(43) Pub. Date: Jun. 20, 2002

(54) Method for starting an HTM fuel cell, and associated device

(76) Inventors: Ulrich Gebhardt, Langensendelbach (DE); Manfred Waidhas, Nurnberg (DE)

Correspondence Address: LERNER AND GREENBERG P.A., Post Office Box 2480, Hollywood, FL, 33022-2480, US

(21) Appl. No.: 09/968,245

(22) Filed: Oct. 1, 2001

Related U.S. Application Data
(63) Continuation of application No. PCT/DE00/00829, filed on Mar. 17, 2000.

(30) Foreign Application Priority Data
Mar. 29, 1999 (DE) 199 14 247.5

(51) Int. Cl. H01M 8/04; H01M 4/86; H01M 8/08; H01M 4/94; H01M 8/02

(52) U.S. Cl. 429/14; 429/34; 429/46; 429/41

(57) ABSTRACT

An HTM fuel cell with reduced flushing-out of electrolyte, an HTM fuel cell battery, and a method for starting an HTM fuel cell includes an electrolyte membrane, the electrolyte having two sides each with an electrode coating adjoined by a gas diffusion layer and a pole plate. The new fuel cell configuration allows the electrolyte to be flushed out and collected and returned to the HTM fuel cell. The method for starting the HTM fuel cell allows the electrolyte, which has been flushed out, to be returned to the cell during normal operation.

### CROSS-REFERENCE TO RELATED APPLICATION

This application is a continuation of copending International Application No. PCT/DE00/00829, filed Mar. 17, 2000, which designated the United States.

### BACKGROUND OF THE INVENTION

Field of the Invention:

The invention relates to a method for starting an HTM fuel cell and to an associated device for carrying out the method. German Published, Non-Prosecuted Patent Application DE 198 44 983 A1 proposes a liquid barrier layer for a fuel cell, in particular, for a Polymer Electrolyte Membrane (PEM) fuel cell. Moreover, the PEM fuel cell, which has a base polymer with attached [—SO₃H] groups as its electrolyte is in the prior art. The electrolytic conduction takes place through hydrated protons. To ensure the proton conductivity, the membrane accordingly requires liquid water, which under normal pressure requires operating temperatures of below 100° C. The requirement results in a problem that the process gases flowing in have to be humidified at temperatures of over approx. 65° C.

A starting point for eliminating the restriction on the operating temperature is that of using a different membrane that may also be an ion exchange membrane and/or a matrix including free and/or physically bonded and/or chemically bonded phosphoric acid as the electrolyte of a fuel cell instead of the membrane that contains [—SO₃H] groups. Such a fuel cell is referred to as a High-Temperature Membrane (HTM) fuel cell.

When producing an HTM fuel cell with free phosphoric acid, the flushing-out of the electrolyte at temperatures below 100° C., i.e., when starting the fuel cell installation, is an undesirable phenomenon. The situation becomes a problem when the fuel cell is operated in start/stop mode, i.e., in mobile applications. The electrolyte loss caused by the electrolyte being flushed out may lead to power losses or even to the cell failing to function. For example, the flushed-out electrolyte can leave the cell together with the process-gas stream. To maintain the ability of the cell to function, electrolyte has to be topped up.

The phenomenon of electrolyte being flushed out is related to the phosphoric acid fuel cell, or PAFC for short. In such a case, however, it is of subordinate importance because the PAFC is used predominantly in stationary, steady-state mode for a prolonged period and most of the electrolyte loss takes place during the starting.

European Patent Application EP 0 181 134 A2 discloses a fuel cell system with a device or means for recovering the electrolyte. In the application, the device is used to remove the electrolyte in a controlled manner and to separate it from what are described as the reactants. Specifically, the reactants are cleaned before entering the atmosphere, and the electrolyte that is removed therefrom is collected in a reservoir.

In addition, Japanese Patent Documents 62-237671 A and 60-121680 A disclose fuel cells in which electrolyte is exchanged and is temporarily stored in vessels. Particularly, in the second document, the fuel cell is a PAFC.

### SUMMARY OF THE INVENTION

It is accordingly an object of the invention to provide a method for starting an HTM fuel cell and an associated device, and associated device that overcomes the hereinafore-mentioned disadvantages of the heretofore-known methods and devices of this general type with the HTM fuel cell remaining able to function without having to top up the electrolyte.

With the foregoing and other objects in view, there is provided, in accordance with the invention, a method for starting an HTM fuel cell including the steps of providing an electrolyte membrane filled with a self-dissociating Bronsted acid, the electrolyte having two sides each with an electrode coating adjoined by a gas diffusion layer and a pole plate, collecting and temporarily storing at least one of flushed out electrolyte and overflowed electrolyte during the starting operation of the fuel cell, and automatically returning the electrolyte to the fuel cell.

Therefore, the invention provides a method for starting an HTM fuel cell in which the flushed out electrolyte is collected and automatically fed back into the cell. It is not necessary to top up the electrolyte.

In accordance with another mode of the invention, the collected electrolyte is purified before the collected electrolyte is returned to the fuel cell.

In accordance with a further mode of the invention, the a process-gas supply line conveying process gas in a given direction after the HTM fuel cell has been started is briefly switched over so that process gas flows in a direction opposite the given direction.

In accordance with an added mode of the invention, a liquid barrier layer is provided in the fuel cell, preferably, between the gas diffusion layer and the pole plate.

In accordance with an additional mode of the invention, a collective reservoir is connected to a plurality of HTM fuel cells through a line.

With the objects of the invention in view, there is also provided an HTM fuel cell configuration including at least one fuel cell having an electrolyte with two sides, each of the sides having an electrode coating adjoined by a gas diffusion layer and a pole plate, a reservoir for collecting and temporarily storing at least one of flushed out electrolyte and overflowed electrolyte, the reservoir connected to the at least one fuel cell, and a recycler for automatically recycling the electrolyte, the recycler connected to the fuel cell and to the reservoir and automatically returning the electrolyte from the reservoir to the fuel cell.

The electrolyte flushed out of the cell can be temporarily stored in the reservoir and kept available again for the cell.

To carry out the invention, there may be a water-barrier layer that is gas-permeable within the HTM fuel cell. The barrier layer may be disposed between the electrode and the gas diffusion layer or the gas conduction layer and the gas chamber, which is delimited by the pole plate. In such configurations, it is advantageous, according to the invention, if the reservoir directly adjoins the HTM fuel cell so that during starting the electrolyte is forced into the reservoir with the product water. And, when the cell is operating, in particular, at an operating temperature over 100° C., the product water evaporates and the resulting capillary vacuum sucks the electrolyte back into the cell.

In accordance with yet another feature of the invention, the electrolyte is an electrolyte membrane filled with a self-dissociating Bronsted acid.

In accordance with yet a further feature of the invention, the at least one fuel cell is a plurality of fuel cells and the reservoir is assigned to a given one of the fuel cells.

In accordance with yet an added feature of the invention, the at least one fuel cell has a liquid barrier layer, preferably, between the gas diffusion layer and the pole plate.

In accordance with yet an additional feature of the invention, the at least one fuel cell is a plurality of HTM fuel cells; and including a line connects the collective reservoir to the plurality of HTM fuel cells.

With the objects of the invention in view, there is also provided an HTM fuel cell configuration battery including a stack having at least one HTM fuel cell with an electrolyte with two sides, each of the sides having an electrode coating adjoined by a gas diffusion layer and a pole plate, a reservoir for collecting and temporarily storing at least one of flushed out electrolyte and overflowed electrolyte, the reservoir connected to the at least one HTM fuel cell, and a recycler for automatically recycling the electrolyte, the recycler connected to the at least one HTM fuel cell and to the reservoir and automatically returning the electrolyte from the reservoir to the at least one HTM fuel cell, and a process-gas line, the reservoir being disposed adjacent the stack in the process-gas line.

In accordance with a concomitant feature of the invention, the electrolyte is an electrolyte membrane filled with a self-dissociating Bronsted acid.

Advantageously, according to the invention, the electrolyte can be simply discharged from the stack together with the process-gas flow. In the embodiment, a collective reservoir is only provided in the cell stack outlet line of the process-gas line. In the collective reservoir, the electrolyte is stored and/or is purified to remove the process exhaust gas and/or the process water before being sucked back into the HTM fuel cell stack, to the individual cells of the stack, e.g., by a capillary effect, through the additional line.

In the invention, the electrolyte may be washed out of the cell together with the process exhaust gas and may be passed into a collective reservoir that adjoins the stack. There, if appropriate, the process exhaust gas and/or the product water may be removed from the electrolyte. After the HTM fuel cell battery has been started, i.e., when the operating temperature, which is preferably higher than 100° C., has been reached, the process-gas line instead of an additional line is then preferably used to return the electrolyte. In such a case, the process-gas line may be switched over, so that the process gas flows in the opposite direction and, therefore, carries the electrolyte back into the cell. In such a case, the line, which is provided from the HTM fuel cell to the reservoir, is identical to the process-gas duct.

As a result of the process-gas pressure being increased on one side of the electrolyte, i.e., on the anode side, it is possible to promote exclusively cathode-side expulsion of the electrolyte during starting and/or when shutting down. Thus, for example, in the case of the air-operated HTM fuel cell, one additional air feed line, for example, from the compressor and/or from the air filter to the reservoir, is sufficient for the cathode air flow to be briefly switched in the opposite direction.

Other features that are considered as characteristic for the invention are set forth in the appended claims.

Although the invention is illustrated and described herein as embodied in a method for starting an HTM fuel cell, and an associated device, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a diagrammatic illustration of an HTM fuel cell according to the invention with liquid barrier layer adjoining a pole plate;

FIG. 2 is a diagrammatic illustration of the fuel cell of FIG. 1 with the liquid barrier layer between the electrode and the gas diffusion layer;

FIGS. 3 and 4 are diagrammatic illustrations of an alternative embodiment of FIGS. 1 and 2 with a liquid barrier layer, in which capillaries are integrated in the electrolyte carrier, and these capillaries draw the electrolyte back into the cell more quickly;

FIG. 5 is a diagrammatic illustration of a device providing a collective reservoir for HTM fuel cells of a fuel stack according to the invention; and

FIG. 6 is a circuit flow diagram of an HTM fuel cell according to the invention with a reservoir where, after starting has taken place, the process-gas flow can be connected to run in the opposite direction so that the electrolyte is carried back into the HTM fuel cell through the process-gas flow.

### DESCRIPTION OF THE PREFERRED EMBODIMENTS

The term high-temperature membrane (HTM) fuel cell denotes any fuel cell that includes a conventional electrolyte membrane and/or that includes a membrane as a matrix for physically and/or chemically taking up the electrolyte as its core component and the operating temperature of which is higher than that of the conventional PEM fuel cell, i.e., higher than 80° C., preferably, higher than 100° C. The maximum operating temperature of such HTM fuel cells is approximately 220° C. The HTM fuel cell has an electrolyte that has a good conductivity in the non-aqueous medium at the above temperatures.

The term electrolyte denotes phosphoric acid, sulfuric acid, sulfurous acid, etc., i.e., all compounds that, within the HTM fuel cell, are physically and/or chemically bonded to a membrane or an inert matrix (referred to below as an electrolyte carrier or carrier) and that effect the electrolytic conduction of the protons within the HTM fuel cell. In the HTM fuel cell, the electrolyte used is preferably phosphoric acid and/or some other self-dissociating Bronsted acid.

The term reservoir denotes any vessel in which electrolyte can be stored and from which, under certain circumstances, product water and/or process exhaust gas can also evaporate.

In a first exemplary embodiment, the vessel is so closely coupled to the HTM fuel cell stack that it is able to adopt the temperature of the HTM fuel cell stack. In such a case, the material of the reservoir is to be selected accordingly, so that it is able to withstand the electrolyte yet can nevertheless be heated without difficulty.

In another exemplary embodiment, a pressure compensation device is included in the reservoir.

In a further exemplary embodiment, the reservoir is made from expandable and/or elastic material with a variable uptake capacity, so that the electrolyte flowing in has a decisive influence on the volume of the reservoir (according to the principle of a balloon and/or a concertina bellows).

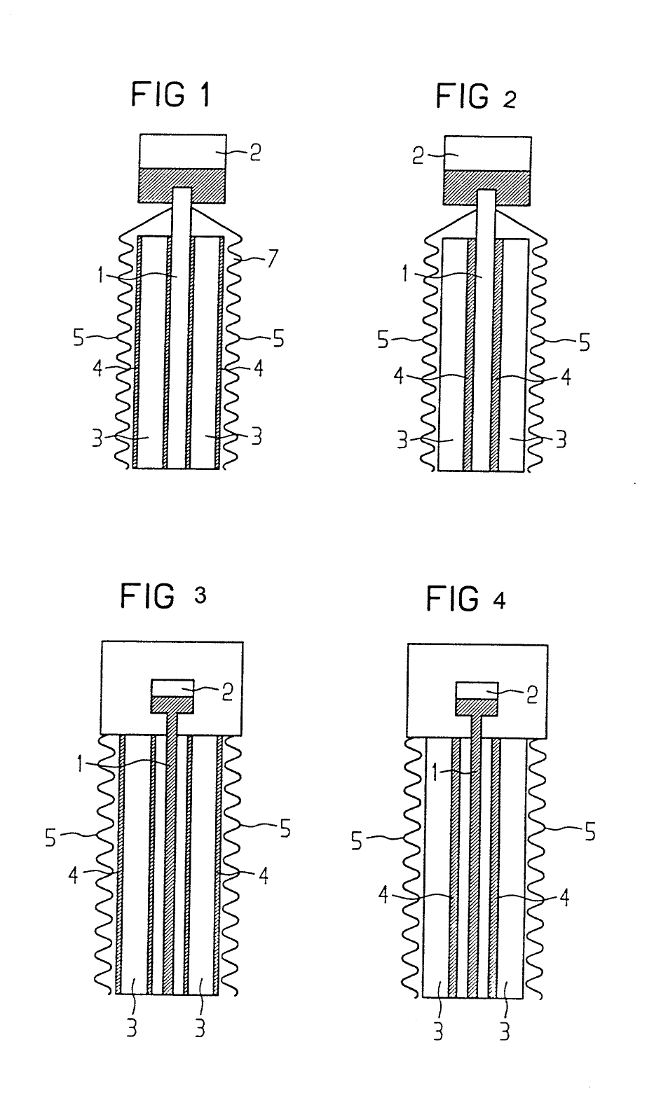

Referring now to the figures of the drawings in detail and first, particularly to FIGS. 1 and 2 thereof, there are shown two HTM fuel cells. The following description applies to both illustrations: in each case in the center there is the electrolyte carrier 1 with electrolyte, i.e., a NAFION membrane with free phosphoric acid. The cell is delimited by the two pole plates 5, which open into the reservoir 2 at the top. The electrolyte carrier 1 also extends into the reservoir 2 so that if the cell overflows the electrolyte together with product water is flushed into the reservoir 2. FIGS. 1 and 2 show the reservoir 2 half full. Two gas diffusion layers 3 with a catalyst covering, for example, carbon fabric or other current collectors, are also included in the HTM fuel cell.

The two HTM fuel cells shown in FIGS. 1 and 2 differ with regard to the configuration of the liquid barrier layer 4 within the cell.

In FIG. 1, a liquid barrier layer 4, for example, a microporous carbon structure, is situated adjacent to the pole plate 5. The structure ensures that the cell does not overflow into the gas-outlet passages 7 of the pole plate 5, rather into the reservoir 2.

In FIG. 2, the liquid barrier layer 4 directly adjoins the electrolyte carrier, so that the electrolyte cannot under any circumstances overflow into the gas diffusion layer 3.

FIGS. 3 and 4 once again show two HTM fuel cells, which are identical apart from the configuration of the liquid barrier layer 4. Unlike the HTM fuel cells shown in FIGS. 1 and 2, the electrolyte carrier, for example, the porous matrix or the membrane, has integrated capillaries and/or passages that are oriented and facilitate and/or accelerate the flow of the electrolyte back out of the reservoir 2.

When the HTM fuel cell is operating, in particular, when the cell reaches a temperature over 100° C., the product water is discharged from the cell in gas form, and a vacuum is generated in the cell. The vacuum, if appropriate with assistance from, preferably oriented capillaries and/or passages in the electrolyte carrier, draws the electrolyte out of the reservoir back into the cell.

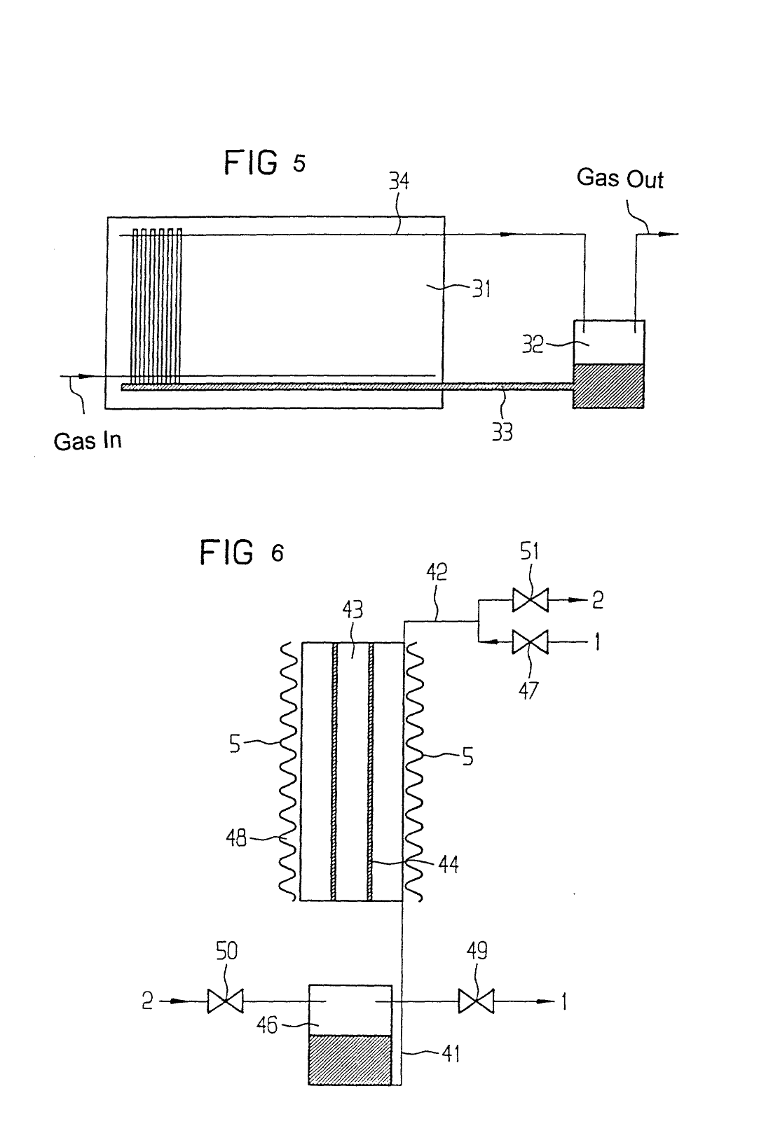

FIG. 5 shows an embodiment in which the liquid barrier layer in the cell can be dispensed with and the overflow of the electrolyte from all the cells of a stack 31 is collected and is guided through the line 33 into the collective reservoir 32. At least one process exhaust-gas line 34 likewise passes through the collective reservoir 32, so that the quantity of electrolyte, which has been discharged from the cells together with the process gas also enters the collective reservoir 32. In the embodiment too, the capillary action of the electrolyte carrier, i.e., of the membrane or of the porous matrix, or simply the vacuum, which is generated during operation, allows the electrolyte to be automatically sucked back into the cell.

A slightly increased reactant pressure on the anode side allows the electrolyte to be discharged only on the cathode side.

FIG. 6 shows an embodiment in which the electrolyte no longer flows back automatically into the cell, but rather is blown back into the cells as a result of the process-gas line being switched over after the starting procedure has taken place. For the sake of clarity, the drawing once again shows an individual cell (as in FIGS. 1 to 4), although it is obvious for the configuration also to be used in a stack. The HTM fuel cell has the electrolyte carrier 43 centrally disposed. The carrier, as in all exemplary embodiments, may have oriented capillaries. The pole plate 5 delimits the cell. The collective reservoir 46, which for the sake of clarity is shown directly beneath the cell in the figure, is disposed at a distance from the cell. When starting, the process gas 1, for example, air, flows through the valve 47, through the line 42, into the gas distribution passages 48 of the cell, where, inter alia, it takes up the overflowing electrolyte. The process gas 1 from the cell, which is enriched with electrolyte vapor and/or droplets, then flows through the line 41 into the collective reservoir 46, where conditions (pressure, temperature, etc.) that lead to at least the electrolyte being separated from the process exhaust gas 1 at that location prevail. The collective reservoir 46 is preferably configured such that there the electrolyte is cleaned before being returned to the cell. The process exhaust-gas 1 line, which leads out of the collective reservoir 46, has a valve 49, which, after the starting operation has ended, i.e., when the operating temperature of the cell is preferably greater than 100° C., is closed. The valve 50 is opened at the same time that the valve 49 is closed. The process gas 2, which is of the same type as the process gas 1, i.e., air, flows through the valve 50 into the collective reservoir 46, preferably through the liquid electrolyte, where conditions are now set such that the process gas 2 is enriched with electrolyte. The process gas 2 leaves the collective reservoir 46 through the line 41 and flows into the HTM fuel cell, through the gas distribution passages 48, in which it releases the electrolyte back to the cell. The process gas 2 leaves the cell again through the process exhaust-gas 2 line 42 and the valve 51. During starting, the valve 51 remains closed.

The invention solves the problem of liquid electrolyte loss from an HTM fuel cell. The invention is configured primarily for starting an HTM fuel cell having an operating temperature of greater than 100° C., but its application to similar (discharge and/or overflow) problems in these or other HTM fuel cells and outside the starting operation is also possible.

We claim:

1. A method for starting an HTM fuel cell, which comprises:
providing an electrolyte membrane filled with a self-dissociating Bronsted acid, the electrolyte having two sides each with an electrode coating adjoined by a gas diffusion layer and a pole plate;
collecting and temporarily storing at least one of flushed out electrolyte and overflowed electrolyte during the starting operation of the fuel cell; and
automatically returning the electrolyte to the fuel cell.

2. The method according to claim 1, which further comprises purifying the collected electrolyte before the collected electrolyte is returned to the fuel cell.

3. The method according to claim 1, which further comprises briefly switching over a process-gas supply line conveying process gas in a given direction after the HTM fuel cell has been started so that process gas flows in a direction opposite the given direction.

4. The method according to claim 1, which further comprises providing a liquid barrier layer in the fuel cell.

5. The method according to claim 1, which further comprises providing a liquid barrier layer in the fuel cell between the gas diffusion layer and the pole plate.

6. The method according to claim 1, which further comprises connecting a collective reservoir to a plurality of HTM fuel cells through a line.

7. An HTM fuel cell configuration, comprising:
at least one fuel cell having an electrolyte with two sides, each of said sides having an electrode coating adjoined by a gas diffusion layer and a pole plate;
a reservoir for collecting and temporarily storing at least one of flushed out electrolyte and overflowed electrolyte, said reservoir connected to said at least one fuel cell; and
a recycler for automatically recycling said electrolyte, said recycler connected to said fuel cell and to said reservoir and automatically returning said electrolyte from said reservoir to said fuel cell.

8. The HTM fuel cell configuration according to claim 7, wherein said electrolyte is an electrolyte membrane filled with a self-dissociating Bronsted acid.

9. The HTM fuel cell configuration according to claim 7, wherein:
said at least one fuel cell is a plurality of fuel cells; and
said reservoir is assigned to a given one of said fuel cells.

10. The HTM fuel cell configuration according to claim 7, wherein said at least one fuel cell has a liquid barrier layer.

11. The HTM fuel cell configuration according to claim 7, wherein said at least one fuel cell has a liquid barrier layer disposed between said gas diffusion layer and said pole plate.

12. The HTM fuel cell configuration according to claim 7, wherein:
said at least one fuel cell is a plurality of HTM fuel cells; and including:
a collective reservoir; and
a line connecting said collective reservoir to said plurality of HTM fuel cells.

13. An HTM fuel cell configuration battery, comprising:
a stack having at least one HTM fuel cell including:
an electrolyte with two sides, each of said sides having an electrode coating adjoined by a gas diffusion layer and a pole plate;
a reservoir for collecting and temporarily storing at least one of flushed out electrolyte and overflowed electrolyte, said reservoir connected to said at least one HTM fuel cell; and
a recycler for automatically recycling said electrolyte, said recycler connected to said at least one HTM fuel cell and to said reservoir and automatically returning said electrolyte from said reservoir to said at least one HTM fuel cell;
a process-gas line, said reservoir being disposed adjacent said stack in said process-gas line.

14. The HTM fuel cell configuration battery according to claim 13, wherein said electrolyte is an electrolyte membrane filled with a self-dissociating Bronsted acid.
